(19) United States
(12) Patent Application Publication
(10) Pub. No.: US 2025/0109291 A1
(43) Pub. Date: Apr. 3, 2025

(54) HOT MELT ADHESIVE COMPOSITIONS BASED ON POLY (ALPHA-METHYL-BETA-PROPIOLACTONE) POLYMERS OR DERIVATIVES AND METHODS FOR USING THEM

(71) Applicant: Bostik SA, Colombes (FR)

(72) Inventors: Steven D. GRAY, Wauwatosa, WI (US); Darius K. DEAK, Wauwatosa, WI (US); Jean-Luc DUBOIS, Colombes (FR)

(21) Appl. No.: 18/725,195

(22) PCT Filed: Dec. 19, 2022
(86) PCT No.: PCT/IB2022/000729

§ 371 Date: Jun. 28, 2024

Related U.S. Application Data
(60) Provisional application No. 63/295,589, filed on Dec. 31, 2021.

(51) Int. Cl. C08L 67/04; C08G 63/08

(52) U.S. Cl. CPC C08L 67/04; C08G 63/08; C08G 2170/20

(57) ABSTRACT

A hot melt adhesive composition comprises a polymer comprising poly(α-methyl-β-propiolactone) (PMPL) or a derivative thereof, wherein the PMPL is polymerized from a plurality of (R)-α-methyl-β-propiolactone monomers and a plurality of (S)-α-methyl-β-propiolactone monomers, wherein the ratio of (R):(S) monomers is from about 90:10 to about 10:90. Changing the (R):(S) ratio impacts the isotactic diad fraction and consequently the crystallinity and thermomechanical properties of the resulting PMPL. The PMPL may be hydroxyl-terminated, with the residue thereof serving as the elastomeric B block in an A:B:A triblock copolymer having hard end A blocks, such as a residue of polylactic acid. The PMPL diol may also be used as a reactant to form an alkoxysilane-terminated polymer, a polyurethane, or a (co)polyester. In some embodiments, such triblock polymers may be entirely bio-sourced and compostable.

### FIELD OF THE INVENTION

This invention relates to hot melt adhesive compositions based on poly(α-methyl-β-propiolactone) polymers or derivatives thereof and methods for using such hot melt adhesives. Such adhesives having these polymers or derivatives as components thereof can be used in a wide range of adhesive applications.

### BACKGROUND OF THE INVENTION

While bio-based and degradable or compostable polymers are well-known, few provide the proper properties to replace styrene block copolymers (SBc) currently used to formulate hot melt adhesive (HMA) and pressure-sensitive adhesive (PSA) products. Current bio-based materials are simply not well-suited to generate the low modulus, elastomeric adhesives with high bonding performance. Currently, there is not a commercial material available that possesses the phase-separated morphology and displays the desired hard-soft behavior offered by SBc-based adhesives or polyolefins, both of which are petroleum-based products and therefore are not from renewable sources, nor are they biodegradable. As used herein, “bio-based” means that the material is made using sustainable sources and not petroleum-based products.

In Macromolecules, 1994, 27, 6018, the authors describe the synthesis of poly(3-hydroxybutyrate) (P(3HB)) by the ring-opening stereocopolymerization of (R)-β-butyrolactone with (S)-β-butyrolactone at various feed ratios of the R:S enantiomers ranging from 96:4 to 50:50. The authors found that the tacticity of P(3HB) varied significantly depending on the feed ratio, ranging from an isotactic diad fraction of 0.92 for the P(3HB) produced from an R:S ratio of 96:4 to an isotactic diad fraction of 0.3 for the P(3HB) produced from an R:S ratio of 50:50. The authors determined the crystallinity and thermomechanical properties of the various P(3HB) produced and found that these properties varied dependent on the various polymers' different tacticity, as shown in Table 1 below:

TABLE 1

| Monomer | Iso- | | [symbol] | | | Ten. | |
|---|---|---|---|---|---|---|---|
| Feed | tactic | Mn | (Mw/ | Tm | ΔHₘ | Strength | Elongation |
| R/S | diads | KDa | Mn) | ° C. | J/g | MPa | % |
| 96/4 | 0.92 | 121 | 1.8 | 156 | 80 | — | — |
| 90/10 | 0.84 | 112 | 1.8 | 132 | 61 | 15 | 7 |
| 85/15 | 0.76 | 115 | 1.7 | 107 | 56 | 11 | 10 |
| 80/20 | 0.68 | 107 | 1.8 | 92 | 43 | 11 | 740 |
| 70/30 | 0.46 | 105 | 1.8 | — | 0 | — | — |
| 50/50 | 0.30 | 145 | 1.8 | 52.62 | 27 | 13 | 1020 |

### SUMMARY OF THE INVENTION

There remains a need to provide biobased and/or degradable or compostable polymers which provide properties suitable to replace styrene block copolymers (SBc) or polyolefins currently used to formulate hot melt adhesive (HMA) and pressure-sensitive adhesive (PSA) products. Such bio-based materials would ideally be well-suited to generate low modulus, elastomeric adhesives with high bonding performance.

In order to meet at least some of the needs described herein, an embodiment of the present invention provides a composition comprising a polymer comprising poly(α-methyl-β-propiolactone) or a derivative thereof, wherein the poly(α-methyl-β-propiolactone) is polymerized from a plurality of (R)-α-methyl-β-propiolactone monomers and a plurality of (S)-α-methyl-β-propiolactone monomers, wherein the ratio of (R):(S) monomers is from about 90:10 to about 10:90 and wherein the composition is a hot melt adhesive.

According to another embodiment of the invention, the hot melt adhesive composition comprises a triblock copolymer having an A:B:A backbone, wherein block B comprises a residue of the poly(α-methyl-β-propiolactone) made from (R) and (S) monomers of α-methyl-β-propiolactone having a first (R):(S) ratio and block A is selected from the group consisting of a residue of polylactic acid, polycaprolactone, polystyrene, polyhydroxybutyrates, poly(methyl methacrylate), poly(α-methyl-β-propiolactone) made from (R) and (S) monomers of α-methyl-β-propiolactone having a second (R):(S) ratio which is different from the first (R):(S) ratio, or polyamides or copolymers thereof.

According to another embodiment of the invention, the hot melt adhesive composition comprises a silane-modified, moisture curable polymer comprising the reaction product of the diol of poly(α-methyl-β-propiolactone) and siloxane. In another embodiment, the hot melt adhesive composition comprises a polyurethane comprising the reaction product of a diol of poly(α-methyl-β-propiolactone) and an isocyanate. In another embodiment, the hot melt adhesive composition comprises a (co)polyester comprising the reaction product of a diol of poly(α-methyl-β-propiolactone) and a diacid or diester.

According to another embodiment of the invention, a method for making a laminate comprises the steps of: applying a hot melt adhesive composition as described herein a molten state to a primary substrate; mating a secondary substrate to the primary substrate by contacting the secondary substrate with the composition; and solidifying the composition by cooling the composition or allowing the composition to cool to form the laminate having solidified hot melt adhesive bonding the primary substrate with the secondary substrate.

### DETAILED DESCRIPTION OF THE INVENTION

The present invention may be understood more readily by reference to the following detailed description of certain embodiments of the invention and the working examples.

An embodiment of the present invention is directed to poly(α-methyl-β-propiolactone) (“PMPL”) or a derivative in a hot melt adhesive composition. PMPL may be synthesized by a ring-opening polymerization of (R,S)-mixtures of α-methyl-β-propiolactone, MPL, to produce PMPL having precisely controlled and tunable levels of stereoregularity. Shown below as structure I is a stereo-controlled poly(α-methyl-β-propiolactone) having a heterotactic diad:

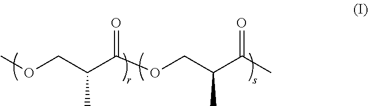

The synthesis of PMPL is well-known in the art, starting from acrylic acid or methacrylic acid. See, e.g., J. Biol. & Chem., 2018, 46 (3), 435. Starting from acrylic or methacrylic acid, racemic mixtures of MPL can be produced via a two-step ring-closing reaction. Shown below in structure IIA is (R)-MPL and in structure IIB is (S)-MPL

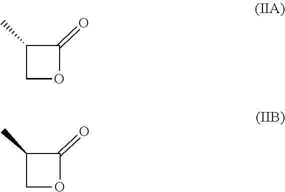

These materials can be enzymatically-resolved to provide highly enantomerically enriched monomers (e.g., up to 93% (R)-enantiomer). This enriched monomer alone can be polymerized with the chiral nature preserved to provide a PMPL with a high degree of stereoregularity with respect to the methyl group pendant to the main chain. Such materials are largely isotactic in nature and, as anticipated, display relatively high crystallinity and melt points. Alternately, the enantomerically-enriched MPL, mostly (R)-MPL, can be blended with racemic MPL, (R,S-MPL), and polymerized to control the isotacticity and, in turn, the themomechanical properties of the PMPL copolymer. This concept as applied to poly(3-hydroxybutyrate) is demonstrated by the range of properties shown in Table 1.

While random copolymers of (R)- and (S)-MPL have been produced, the present invention is based on the application of the technology described in the 1994 Macromolecules article cited above to produce PMPL with a controlled degree of stereoregularity and the use of that material as a component in a hot melt adhesive.

An embodiment of the invention is directed to a hot melt adhesive composition comprising a polymer comprising poly(α-methyl-β-propiolactone) or a derivative thereof, wherein the poly(α-methyl-β-propiolactone) (PMPL) is polymerized from a plurality of (R)-α-methyl-β-propiolactone monomers and a plurality of (S)-α-methyl-β-propiolactone monomers, wherein the ratio of (R):(S) monomers is from about 90:10 to about 10:90. As a hot melt adhesive, the composition of the present invention is one which contains no carrier fluid, such as water or any other solvent, when applied to a substrate, and is solid at room temperature. Hot melt adhesives are heated to a molten state before application to a substrate, then cooled forming a bond with the substrate. In some embodiments of the invention, the adhesive is pressure-sensitive, meaning that it is tacky after cooling to room temperature; such adhesives are known as hot melt pressure sensitive adhesives. Pressure sensitive adhesives will stick to a surface with light pressure. In embodiments of the invention, the compositions are pressure sensitive adhesives having a storage modulus, G′, at room temperature of at most 3×10⁶ dyne/cm² (0.3 MPa).

Stereo-controlled PMPL is shown below is structure III:

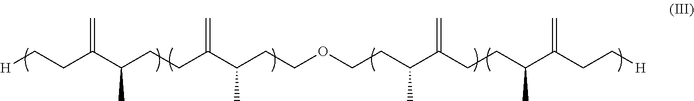

Although shown above in structure (III) as having terminal hydroxyl groups (and, as such, is a diol), the PMPL may have other terminal groups as is well-known in the art, such as carboxylic acid end groups, isocyanate end groups, or (meth)acrylate end groups. Accordingly, as used herein, “PMPL” refers to a polymer having structure III above or with other end groups in place of the hydroxyl groups. When a diol of PMPL is specified herein, that is referring to a PMPL having hydroxyl end groups, such as that shown in structure III.

To display chemical compatibility as well as proper mechanical properties in adhesive formulations, the net feed ratio of R:S monomers is in the range of 90:10 to 10:90. In some embodiments, the melt point, Tm (as measured by DSC in accordance with ASTM D7138) is desired to be in the range of 30 to 150° C., which provides adhesives with proper thermal and creep resistance while still being able to melt and be applied to even thermally-sensitive substrates. As formulation components, such materials would be of a similar nature as polyolefins currently employed in hot melt adhesive applications. Conversely, for other applications such as for use as a pressure sensitive adhesive, the materials can be amorphous, show no Tₘ by DSC, and possess glass transition values between −90 and 30° C. In an embodiment for applications requiring a pressure sensitive adhesive, the PMPL polymer is made from monomers having an (R):(S) ratio over a range which provides, or ranges which provide, a PMPL polymer which is either: (1) crystalline and has a melting point below 30° C., preferably below 25° C. and/or (2) amorphous and has no detectable melting point. It should be pointed out that the trend indicated in Table 1 of decreasing isotactic diad fraction as the R:S ratio approaches 50:50 would not necessarily continue as the R:S ratio is reduced further. The isotactic diad fraction might decrease as the R:S ratio is reduced below 50:50. On the other hand, the thermomechanical trends shown in Table 1 might be expected to trend towards more crystalline behavior and could potentially either generally or fairly precisely be a mirror image of the values for the thermomechanical properties as the R:S ratio decreases from 96:4 to 50:50 (e.g., the thermomechanical properties of PMPL formed from an R:S ratio of 70:30 might be similar to the thermomechanical properties of PMPL formed from an R:S ratio of 30:70).

By utilizing monomers fed over such a range of the (R):(S) ratio, a polymer product having suitable thermomechanical properties may be utilized as a component in a hot melt adhesive formulation. As noted above, the polymer might be PMPL itself or a derivative thereof. As used herein, a derivative includes a reaction product of PMPL and another compound or macromolecule (which includes polymers). For example and as described in more detail below, derivatives of PMPL include a polymer having an A:B:A structure wherein a residue of the PMPL is one of blocks A or B, typically B, and another polymer, such as polylactic acid, serves as the other block, typically block A. Derivatives of PMPL also include a silane-modified, moisture curable polymer; a polyurethane; and a (co)polyester formed by reacting a diol of PMPL with, respectively, siloxane, an isocyanate, and a diacid or diester. As used herein, the terms “residue” or “reaction product” shall mean the product of a reactant, such as the moiety remaining from a monomer in a polymer or remaining from a polymer in a reaction product of that polymer (e.g., block B as it appears in an A:B:A block copolymer, namely with a reacted end group that is now a linking group to block A). For example, the residue of a diol initiator HO-D-OH is the moiety —O-D-O—.

The PMPL used in the hot melt adhesive may be the PMPL itself, including a diol of PMPL as shown in structure III. Such a PMPL may be formulated with appropriate placticizers, tackifiers, and other additives to provide a variety of types of adhesives for various applications with performance properties as needed for the particular application. In an embodiment of the invention, a hot melt adhesive comprises tackifiers and other additives but no plasticizer.

Alternatively, a derivative of PMPL may be used in the hot melt adhesive. As mentioned above, one such derivative is a triblock copolymer having an A:B:A backbone, wherein block B comprises a residue of the poly(α-methyl-β-propiolactone) made from the (R) and (S) monomers having a first (R):(S) ratio and block A is selected from the group consisting of a residue of polylactic acid, polycaprolactone, polystyrene, polyhydroxybutyrates, poly(methyl methacrylate), poly(α-methyl-β-propiolactone) made from the (R) and (S) monomers having a second (R):(S) ratio which is different from the first (R):(S) ratio, or polyamides or copolymers thereof.

In an embodiment of the invention in which such diol-terminated PMPL polymers are employed to produce tri-block copolymers, the PMPL polymers can serve as diol-macromonomer initiators in ring-opening trans-esterification polymerization (ROTEP) of lactide to provide triblock species with another polymer backbone as end-blocks. Thus, an embodiment of the invention is a triblock copolymer having an A:B:A backbone, wherein block B comprises the residue of the any of the PMPL diol polymers described above, and block A selected from the group consisting of a residue of polylactic acid, polycaprolactone, polystyrene, polyhydroxybutyrates, poly(methyl methacrylate), poly(α-methyl-β-propiolactone) made from the (R) and (S) monomers having a second (R):(S) ratio which is different from the first (R):(S) ratio, or polyamides or copolymers thereof. In an embodiment, block A is the residue of any ring-opened polymerized product of lactide. This includes polylactide copolymers of lactic acid and lactones, such as glycolide and caprolactone. In a preferred embodiment, block A comprises, consists essentially of, or consists of a residue of polylactic acid. As will be recognized by one of ordinary skill in the art, reference herein to a polymer in a block structure means the residue of that polymer as it is in the form of a block copolymer.

Alternatively, the triblock systems can be prepared via living ROTEP using a non-diol initiator and sequential monomer addition. Similar methods may be employed to produce both di- and multi-block copolymers. Free radical polymerization and other polymerization methods may be used to make the triblock copolymers of the present invention. The molar percents of the two blocks may vary over a wide range, with the triblock copolymer comprising 95 to 40 molar percent of the block B and 60 to 5 molar percent of the block A, preferably 95 to 60 molar percent of block B and 40 to 5 molar percent of block A.

The most preferred end-blocks (i.e., referred to herein also as block A) are materials known to display biodegradability or composability like that of the PMPL mid-block. The end-blocks should display high modulus values—in the range of 10⁶ to 10⁹ Pa at room temperature—to provide toughness and thermal resistance to the material. Towards this end, these “hard blocks” can be crystalline in nature displaying melt points, Tm, in the range of 60 to 165° C. Alternatively, the end-blocks may be amorphous species with Tg values ranging from 40 to 200° C. In contrast, the mid-block (i.e., block B) is elastomeric or rubbery and has a lower Tg and preferably at most 40° C., preferably at most 30° C., more preferably at most 25° C., and still more preferably at most 0° C., and most preferably at most −20° C., all depending on the needs presented by the ultimate application of the block polymer. The most preferred inventive PMPL polymers for use in pressure sensitive adhesive applications are those that show little crystallinity or are completely amorphous. If crystalline, block B may have a melting point, Tm, below 30° C., preferably below 25° C. In another embodiment, block B is amorphous and has a melting that is not detectable by DSC.

For optimal performance in a preferred embodiment, the end-blocks may be designed to display poor miscibility with the PMPL mid-block leading to distinct phases in the block copolymer. Poor miscibility can be demonstrated by the two blocks showing microphase separation, as evidenced by differences in crystallinity and/or distinct glass transition temperatures, Tg, in the DSC. This can be noted by seeing only minor shifts in the Tg values of any signals present in the DSC of the block copolymers; if one of the materials is present at low amounts—for example in a 5-90-5 triblock copolymer—end-block signals are typically weak and cannot be seen for the lower weight percent fraction. The phase separation is helpful in certain applications as it enables the polymer to display the positive features of the individual segments. For example, polymers having a low modulus at room temperature while still having good thermal resistance or ability to set up quickly and yet still provide creep resistance may serve well in an elastic adhesive application. Miscibility can result in the materials displaying compromised properties between those of the individual segments and closer to those of a random copolymer made from the materials. Materials showing good miscibility between blocks may still find utility in hot melt adhesives or in other applications not requiring high tack at room temperature, however.

In the embodiment in which block A is poly(α-methyl-β-propiolactone) made from the (R) and (S) monomers having a second (R):(S) ratio which is different from the first (R):(S) ratio, it is preferable that these two ratios are sufficiently different to permit at least some level of discernible phase separation between blocks A and B. In one embodiment, for example, there is at least a 10%, preferably at least a 20%, and more preferably at least a 30% difference in one or more of the following properties between blocks A and B: Degrees of crystallinity, melting points, heats of fusion, and glass transition temperatures.

Block A, such as the PLA end-groups, can be made from various isomers of monomers. For example, the PLA end groups may be made from a racemic mixture of the D- and L-stereoisomers; from lactide monomers consisting essentially of, or consisting of, L-lactide stereoisomers; or from lactide monomers consisting essentially of, or consisting of, D-lactide stereoisomers. The selection of the stereochemistry of the monomers of the end blocks may be based on the desired thermal properties of the block copolymer. The racemic mixture provides crystalline end-blocks as does the L-isomer, melting in the range of 150-200° C.; polymers from the D isomer, on the other hand, are amorphous and display Tg values in the range of 50-70° C.

In embodiments of the invention, the PMPL polymer or the triblock copolymer made therefrom are compostable. As used herein, the term “compostable” as applied to an adhesive is an adhesive which meets the requirements of either: (1) the Disintegration Testing as defined by ASTM D 6400-12 (using ISO 20200) (84 day compost exposure) or (2) the Aerobic Biodegradation as defined by ASTM D 6400-12 (using ASTM 5338-15) (at 58±2° C. at 141 days). In other words, the adhesive will reach a minimum of 90% weight loss within 84 days under the Disintegration Testing conditions or will have reached at least 90% carbon conversion (based on CO₂ production) within 141 days according to the Aerobic Biodegradation testing as defined by ASTM D 6400-12 (using ASTM 5338-15) (at 58±2° C. at 141 days). In preferred embodiments, the adhesive meets the requirements of both: (1) the Disintegration Testing as defined by ASTM D 6400-12 (using ISO 20200) (84 day compost exposure) and (2) the Aerobic Biodegradation as defined by ASTM D 6400-12 (using ASTM 5338-15) (at 58±2° C. at 141 days).

In terms of molecular weight, the inventive PMPL polymers possess a degree of polymerization, m, of any suitable range, typically anywhere from 20 to 2,000 (preferably 30 to 1,000) with number average molecular weights, Mn, of m×MW MPL monomer; as ROTEP is living in nature and gives polydispersity values only slightly above 1, the weight average Mw values will be very close to the Mn. Molecular weight values of the inventive polymers can be determined using a variety of methods including NMR analysis as well as those well-known in the art. Values herein refer to absolute values based on degree of polymerization. In the case of diol initiated ROTEP, m may be between 10-1000 as branches grow off both sides of the diol. For the hard segments in block copolymers, the degree of polymerization, n, can be of any suitable range, typically between 20-1000.

In terms of block copolymer composition, any combination of m and n values can be used depending on a number of factors including the adhesive application, with n referring to the degree of polymerization of block A. Most preferred will be those containing 95 to 40 molar percent of the inventive PMPL and 60 to 5 molar percent of the “hard” end block segments such that the overall storage modulus (G′) of the block copolymer is not substantially higher than 10⁶ Pa at room temperature to maintain tack when formulated. In other embodiments, block A has a storage modulus (G′) from 10⁶ to 10⁹ Pa at 25° C.

In accordance with an embodiment of the invention, a hot melt adhesive comprises: the triblock copolymer described above; the silane-modified, moisture curable polymer made from reacting a PMPL polymer of the present invention which is a diol with a siloxide; the polyurethane made from reacting a PMPL polymer of the present invention which is a diol with a diisocyanate; or the (co)polyester made reacting a PMPL polymer of the present invention which is a diol with a diacid or a diester. Similarly, in accordance with another embodiment of the invention, a pressure sensitive adhesive comprises: the triblock copolymer described above; the silane-modified, moisture curable polymer made from reacting a PMPL polymer of the present invention which is a diol with a siloxide; the polyurethane made from reacting a PMPL polymer of the present invention which is a diol with a diisocyanate; or the (co)polyester made reacting a PMPL polymer of the present invention which is a diol with a diacid or a diester. Such adhesives may further comprise a tackifier, a plasticizer, and, optionally, other additives. Such additives may include, for example, such materials as ultraviolet light (UV) absorbers, waxes, surfactants, inert colorants, titanium dioxide, fluorescing agents and fillers. Typical fillers include talc, calcium carbonate, clay silica, mica, wollastonite, feldspar, aluminum silicate, alumina, hydrated alumina, glass microspheres, ceramic microspheres, thermoplastic microspheres, baryte and wood flour and may be included in an amount up to 60% by weight, and preferably between 1 and 50% by weight.

In an embodiment of the invention, a method of making a laminate comprises the steps of: (1) applying the hot melt adhesive composition of the invention in a molten state to a primary substrate; (2) mating a secondary substrate to the primary substrate by contacting the secondary substrate with the adhesive composition; and (3) solidifying the composition by cooling the composition or allowing the composition to cool to form the laminate having solidified hot melt adhesive bonding the primary substrate to the secondary substrate. In an embodiment, at least one of the primary substrate or the secondary substrate is elastic. The primary substrate may be an elastic portion of a diaper, such as an elastic strand used as part of a leg cuff of a diaper or an elastic band used as a back ear laminate of a diaper. Such elastic strands (or bands) and their application as part of a leg cuff of a diaper are shown in U.S. Pat. No. 5,190,606, incorporated herein by reference. The secondary substrate may comprise a nonwoven material, fabric, or a film, such as a spunbond/meltblown/spunbond (SMS) nonwoven fabric or polyethylene film, and the method may include folding the secondary substrate around the elastic strand or wrapping it around the elastic strand. In this way, only the secondary substrate may serve as the substrate which encapsulates the strand or strands of the leg cuff.

In an alternative embodiment, a tertiary substrate is used, and the secondary and tertiary substrates may be mated to the elastic strand on opposite sides of the elastic strand. In such an embodiment, the secondary substrate may be a polyethylene film and the tertiary substrate may be a film of nonwoven material, or verse visa. Furthermore, a composite diaper backsheet consisting of a polyolefin film joined to a nonwoven fabric can also be used as the secondary and tertiary substrates mentioned above.

In other embodiments in which the primary substrate is an elastic strand, the secondary substrate may be a polyethylene film and a tertiary substrate, such as a nonwoven fabric, may be adhered to the film. In embodiments in which the primary substrate is a nonwoven fabric, the secondary substrate may be an elastic film.

A laminate made by any of the methods described herein may be used as an elastic leg cuff, a standing leg cuff, an elastic side panel, or a stretch ear in a disposable article. Such laminates have an elastic substrate and at least one other substrate.

In an alternative embodiment of the invention, a method of making an adhesive product (such as a tape or a label) comprises heating the hot melt adhesive according to any embodiment of the invention described herein to form a molten adhesive; applying the molten adhesive to a first substrate; and allowing the molten adhesive to cool. As the adhesive cools, it forms a bond with the first substrate. In one embodiment, the first substrate is a tape or label substrate and is compostable. Thus, the product formed is a tape product or a label, which can be adhered to another substrate at room temperature. In another embodiment, the first substrate is a release liner and the method further comprises transferring the adhesive from the release liner to a second substrate prior to allowing the molten adhesive to cool. In a known way, the timing of transferring the adhesive from the release liner to the second substrate depends on a number of factors, but it is almost always done before the adhesive is cooled entirely to room temperature.

The material of the substrates could vary over a wide range and include standard substrates, such as PET and metallized PET, and, preferably, compostable or biodegradable substrates, such as polylactic acid, polybutylene succinate (PBS), cellulose-based substrates, and polyhydroxy alkanoates (PHA). The substrate could be roll stock used for making a bag, pouch, or sachet.

The step of applying the molten adhesive to a first substrate may be any suitable method. For example, the molten adhesive may be applied to the first substrate by immersion or dip coating, roll-coating, reverse roll coating, spraying, knife over-roll coating, air-knife coating, or slot die processes. Similarly, contacting the adhesive product surface with the adherend in use (e.g., a letter, container, or piece of fruit) can be done in any known manner, such as by applying pressure. The contacting step is preferably done at a time and at a pressure sufficient to bond the adhesive product to the adherend.

The invention further relates to compostable articles of manufacture. The articles include wrappers, packaging, and food containers sealed together by a hot melt adhesive according to the present invention. Preferably, the substrates to which the hot melt adhesives of the present invention are applied are also compostable, such that the article (also referred to as adhesive product herein) is itself compostable.

One aspect of the invention is to develop elastomeric, rubber-like polymers. From a mechanical property standpoint, embodiments of the inventive PMPL polymers are designed to display low storage modulus values. In embodiments of the invention, the PMPL polymers described above have at least one, preferably at least two, more preferably at least three, still more preferably at least 4, and most preferably all five of the following characteristics:
a. A storage modulus of G′<10⁶ Pa from at room temperature;
b. Elongation at break values of between 100-3,000%;
c. Low melting points (Tm<60° C., preferably less than 30° C. for pressure sensitive adhesives) or no melt point discernible by DSC;
d. No or low crystallinity (as evidenced by DSC); and
e. A glass transition temperature, Tg, of between about −100 to 60° C., preferably no more than 20° C.

The rheology of a given hot melt adhesive can be determined using a TA Instruments rheometer, such as an Ares 3 model, consistent with Dynamic Temperature Testing described in ASTM D4440-01. A temperature step procedure may be used to determine the storage modulus, G′, at various temperatures. The instrument may be set to a frequency of 10 radians per second, the sample may be melted at 170° C., and the temperature may be reduced to −40° C. at 10° C. per minute. The parallel plates may have a 25 mm diameter and a 1.6 millimeter gap. As used herein elongation at break values are determined in accordance with ASTM D638. The melting point, Tm, is determined according to ASTM D7138 using DSC, and glass transition temperature is determined in accordance with according to ASTM D3417.

As can be recognized, such low modulus PMPL polymers could find utility in a variety of applications. For example, PMPL polymers of the present invention which are diols can be reacted with diacids or diesters to make (co)polyesters, or they can be reacted with diisocyanates to make polyurethanes. Similarly, they could be reacted with acid-terminated polyesters or NCO-end capped polyurethanes to provide species with compostable/biodegradable elastomeric blocks. Another method of the invention comprises reacting the diols of PMPL of the present invention with siloxides to form alkoxysilane-terminated oligomer or polymer, for example having —Si(OMe)₃ and —Si(OEt)₃ end groups, to provide moisture curable polymers. The end groups of the inventive PMPL polymers may also be controlled depending on the ring-opening polymerization process employed. A long-chain diol such as hydroxyl-terminated polymer like polyethylene glycol or polypropylene glycol could also be employed as initiators to impart flexibility to the main polymer chain.

As used herein, whenever multiple ranges or multiple lower limits and multiple upper limits are provided for a parameter, the invention includes any range from any lower limit to any upper limit for that parameter.

### ASPECTS OF THE INVENTION

Aspect 1. A composition comprising a polymer comprising poly(α-methyl-β-propiolactone) or a derivative thereof, wherein the poly(α-methyl-β-propiolactone) is polymerized from a plurality of (R)-α-methyl-β-propiolactone monomers and a plurality of (S)-α-methyl-β-propiolactone monomers, wherein the ratio of (R):(S) monomers is from about 90:10 to about 10:90, wherein the composition is a hot melt adhesive.

Aspect 2. The composition of Aspect 1, wherein the polymer is poly(α-methyl-β-propiolactone) diol.

Aspect 3. The composition of Aspect 1, wherein the polymer is a derivative of poly(α-methyl-β-propiolactone).

Aspect 4. The composition of Aspect 1, wherein the polymer is a triblock copolymer having an A:B:A backbone, wherein block B comprises a residue of the poly(α-methyl-β-propiolactone) made from the (R) and (S) monomers having a first (R):(S) ratio and block A is selected from the group consisting of a residue of polylactic acid, polycaprolactone, polystyrene, polyhydroxybutyrates, poly(methyl methacrylate), poly(α-methyl-β-propiolactone) made from the (R) and (S) monomers having a second (R):(S) ratio which is different from the first (R):(S) ratio, or polyamides or copolymers thereof.

Aspect 5. The composition of Aspect 4, wherein block A has a melting temperature (Tm) of above 30° C., preferably between 50° C. and 150° C., more preferably between 60° C. and 140° C.

Aspect 6. The composition of Aspect 4 or 5, wherein block A has a storage modulus (G′) from 10⁶ to 10⁹ Pa at 25° C.

Aspect 7. The composition of any of Aspects 4-6, wherein block B has a degree of polymerization 20 and 2,000, preferably between 30 and 1,000.

Aspect 8. The composition of any of Aspects 4-7, wherein the triblock copolymer comprises 95 to 40 molar percent of the block B and 60 to 5 molar percent of the block A.

Aspect 9. The composition of any of Aspects 4-8, wherein block A is a ring-opened polymerized product of lactide.

Aspect 10. The composition of Aspect 9, wherein block A is the residue of polylactic acid and the polylactic acid is made from a racemic mixture of lactide monomers.

Aspect 11. The composition of Aspect 9, wherein the polylactic acid is made from a lactide monomers consisting essentially of L-lactide stereoisomers.

Aspect 12. The composition of Aspect 9, wherein the polylactic acid is made from a lactide monomers consisting essentially of D-lactide stereoisomers.

Aspect 13. The composition of Aspect 1, wherein the polymer comprises a silane-modified, moisture curable polymer comprising the reaction product of a diol of poly(α-methyl-β-propiolactone) and siloxane.

Aspect 14. The composition of Aspect 1, wherein the polymer comprises a polyurethane comprising the reaction product of a diol of poly(α-methyl-β-propiolactone) and an isocyanate.

Aspect 15. The composition of Aspect 1, wherein the polymer comprises a (co)polyester comprising the reaction product of a diol of poly(α-methyl-β-propiolactone) and a diacid or diester.

Aspect 16. The composition of any of Aspects 1-15 further comprising a tackifier, a plasticizer, and, optionally, other additives.

Aspect 17. A method of making a laminate comprising the steps of:
applying the composition of claim 1 in a molten state to a primary substrate;
mating a secondary substrate to the primary substrate by contacting the secondary substrate with the composition; and
solidifying the composition by cooling the composition or allowing the composition to cool to form the laminate having solidified hot melt adhesive bonding the primary substrate to the secondary substrate.

1. A composition comprising a polymer comprising poly(α-methyl-β-propiolactone) or a derivative thereof, wherein the poly(α-methyl-β-propiolactone) is polymerized from a plurality of (R)-α-methyl-β-propiolactone monomers and a plurality of (S)-α-methyl-β-propiolactone monomers, wherein the ratio of (R):(S) monomers is from about 90:10 to about 10:90, wherein the composition is a hot melt adhesive.

2. The composition of claim 1, wherein the polymer is poly(α-methyl-β-propiolactone) diol.

3. The composition of claim 1, wherein the polymer is a derivative of poly(α-methyl-β-propiolactone).

4. The composition of claim 1, wherein the polymer is a triblock copolymer having an A:B:A backbone, wherein block B comprises a residue of the poly(α-methyl-β-propiolactone) made from the (R) and (S) monomers having a first (R):(S) ratio and block A is selected from the group consisting of a residue of polylactic acid, polycaprolactone, polystyrene, polyhydroxybutyrates, poly(methyl methacrylate), poly(α-methyl-β-propiolactone) made from the (R) and (S) monomers having a second (R):(S) ratio which is different from the first (R):(S) ratio, or polyamides or copolymers thereof.

5. The composition of claim 4, wherein block A has a melting temperature (Tm) of above 30° C.

6. The composition of claim 4, wherein block A has a storage modulus (G′) from 10⁶ to 10⁹ Pa at 25° C.

7. The composition of claim 4, wherein block B has a degree of polymerization 20 and 2,000.

8. The composition of claim 4, wherein the triblock copolymer comprises 95 to 40 molar percent of the block B and 60 to 5 molar percent of the block A.

9. The composition of claim 4, wherein block A is a ring-opened polymerized product of lactide.

10. The composition of claim 9, wherein block A is the residue of polylactic acid and the polylactic acid is made from a racemic mixture of lactide monomers.

11. The composition of claim 9, wherein the polylactic acid is made from a lactide monomers consisting essentially of L-lactide stereoisomers.

12. The composition of claim 9, wherein the polylactic acid is made from a lactide monomers consisting essentially of D-lactide stereoisomers.

13. The composition of claim 1, wherein the polymer comprises a silane-modified, moisture curable polymer comprising the reaction product of a diol of poly(α-methyl-β-propiolactone) and siloxane.

14. The composition of claim 1, wherein the polymer comprises a polyurethane comprising the reaction product of a diol of poly(α-methyl-β-propiolactone) and an isocyanate.

15. The composition of claim 1, wherein the polymer comprises a (co)polyester comprising the reaction product of a diol of poly(α-methyl-β-propiolactone) and a diacid or diester.

16. The composition of claim 1 further comprising a tackifier, a plasticizer, and, optionally, other additives.

17. A method of making a laminate comprising the steps of:
applying the composition of claim 1 in a molten state to a primary substrate;
mating a secondary substrate to the primary substrate by contacting the secondary substrate with the composition; and
solidifying the composition by cooling the composition or allowing the composition to cool to form the laminate having solidified hot melt adhesive bonding the primary substrate to the secondary substrate.

18. The method of claim 17, wherein the polymer is poly(α-methyl-β-propiolactone) diol.
